(19) United States
(12) Patent Application Publication
(10) Pub. No.: US 2020/0080471 A1
(43) Pub. Date: Mar. 12, 2020

(54) METHOD FOR OPERATING AN INTERNAL COMBUSTION ENGINE, DEVICE, AND INTERNAL COMBUSTION ENGINE

(71) Applicant: MTU Friedrichshafen GmbH, Friedrichshafen (DE)

(72) Inventors: Günther Schmidt, Friedrichshafen (DE); Ralf Speetzen, Friedrichshafen (DE)

(73) Assignee: MTU Friedrichshafen GmbH, Friedrichshafen (DE)

(21) Appl. No.: 16/687,006

(22) Filed: Nov. 18, 2019

Related U.S. Application Data
(63) Continuation of application No. PCT/EP2018/062535, filed on May 15, 2018.

(30) Foreign Application Priority Data
May 18, 2017 (DE) 10 2017 110 855.6

(51) Int. Cl. F02B 39/04; F02B 75/02; F02B 25/14; F02B 63/06; F02B 39/12; F02B 41/10; F02B 69/06; F02D 23/00; F01N 5/04

(52) U.S. Cl. CPC F02B 39/04; F02B 75/02; F02B 25/14; F02B 63/06; F02B 39/12; F02B 2075/027; F02B 69/06; F02D 23/005; F01N 5/04; F02B 2075/025; F02B 41/10

(57) ABSTRACT

A method for operating an internal combustion engine, device, and an internal combustion engine including a motor which has a crankshaft. A charge air flow is supplied to the motor that is compressed by means of a compressor via a second rotational movement, and a power turbine for producing a first rotational movement is acted on by an exhaust gas flow discharged from the motor. The following steps are provided: in a first operating mode, operating the internal combustion engine in four-stroke operation, and in a second operating mode, operating the internal combustion engine in two-stroke operation. The crankshaft can be driven by the power turbine via the first rotational movement, and the compressor can be driven by the crankshaft via the second rotational movement, wherein the second rotational movement for the compressor can be set differently from the first rotational movement of the power turbine.

### CROSS REFERENCE TO RELATED APPLICATIONS

This is a continuation of PCT application No. PCT/EP2018/062535, entitled “METHOD FOR OPERATING AN INTERNAL COMBUSTION ENGINE, DEVICE, AND INTERNAL COMBUSTION ENGINE”, filed May 15, 2018, which is incorporated herein by reference.

### BACKGROUND OF THE INVENTION

### 1. Field of the Invention

The invention relates to a method for operating an internal combustion engine.

### 2. Description of the Related Art

Advantageous solutions for the improved charging of internal combustion engines are known in the prior art. For example, DE 10 2010 043 027 A1 describes an internal combustion engine having a compressor which can be driven by a drive separate from the internal combustion motor.

Further, DE 10 2011 079 036 A1 describes an internal combustion engine, having an internal combustion motor with an exhaust gas side and a charge fluid side and a charging system comprising an exhaust gas turbocharger for charging the internal combustion motor, with a compressor arrangement on the charge fluid side and a turbine arrangement on the exhaust gas side, and a compressor whose primary side is connected to the charge fluid side and whose secondary side is connected to the exhaust gas side. Here, there is provided an electric machine which is designed as a motor/generator and which is coupled to the internal combustion motor, wherein the electric machine can be driven as a generator by the internal combustion motor or, as a motor can drive the internal combustion motor, and wherein the compressor can be driven directly by the electric machine via a mechanical drive coupling.

Methods for operating an internal combustion engine independently of a charging, in particular for switching a motor from four-stroke operation to two-stroke operation, are likewise generally known.

U.S. Pat. No. 7,421,981 describes a switching mechanism which can selectably switch between a two-stroke operation and a four-stroke operation of a motor, wherein the switching mechanism can be switched between the engagement with a first cam lobe for a four-stroke operation and the engagement with a second cam lobe for a two-stroke operation.

This fundamentally advantageous approach is distinguished by selective switchability between two-stroke operation and four-stroke operation depending on constraints and requirements during operation.

It is desirable for a method for operating a charged internal combustion engine to be improved further still, in particular with regard to technical and economical aspects.

### SUMMARY OF THE INVENTION

This is where the present invention comes in, the object of which is to specify in an improved manner a method which addresses at least one of the aforementioned problems, in particular concerning a possibility of switching between two-stroke operation and four-stroke operation of a charged internal combustion engine.

The object, concerning the method, is achieved by the present invention which includes a motor which has a crankshaft, wherein a charge air flow supplied to the motor is compressed by means of a compressor via a second rotational movement, and a power turbine for producing a first rotational movement is acted on by an exhaust gas flow discharged from the motor. The invention also relates to an internal combustion engine which is operated according to the method and also to a device for operating the internal combustion engine.

The present invention is based on a method for operating an internal combustion engine that includes a motor which has a crankshaft, wherein a charge air flow supplied to the motor is compressed by a compressor via a second rotational movement, and a power turbine for producing a first rotational movement, is acted on by an exhaust gas flow discharged from the motor.

According to the invention, the method further comprises the steps: in a first operating mode, operating the internal combustion engine in four-stroke operation, and in a second operating mode, operating the internal combustion engine in two-stroke operation.

According to the invention, there is further provision in the method that the crankshaft can be driven by the power turbine via the first rotational movement, and the compressor can be driven by the crankshaft via the second rotational movement, wherein the second rotational movement for the compressor can be set differently from the first rotational movement of the power turbine.

This means in particular that the power turbine and compressor are as it were “mechanically decoupled”, that is to say especially “not directly mechanically connected to one another”. Consequently, power turbine and compressor can be coupled independently of one another to a crankshaft of the motor in a mechanical and torque-transmitting manner.

The invention is based on the consideration that a possibility of switching between two-stroke operation and four-stroke operation during the operation of an internal combustion engine is associated with significant advantages. These advantages concern the greater flexibility for achieving optimum operating states of the engine, in particular with regard to consumption, power and pollutant emissions. In a two-stroke motor, the actual power with the same installation space and weight of the motor is by up to about 70% higher than in a four-stroke motor. This is contrasted by design-related disadvantages of the two-stroke motor, in particular the higher fuel consumption and higher pollutant emissions. In particular, a possibility of switching between two-stroke operation and four-stroke operation allows the advantages of both operation types to be combined.

The invention has now moreover recognized that, with the use of suitable scavenging methods, in two-stroke operation, the motor of a charged internal combustion engine is also advantageously suitable for the implementation of both operation types, namely four-stroke operation and two-stroke operation.

The invention has furthermore recognized that, for both operation types, namely two-stroke and four-stroke operation, different scavenging pressures or scavenging gradients are required. Here, the pressure gradient refers to the pressure difference between compressed fresh, or charge, air after compression and the exhaust gas discharged from the motor before entry into the power turbine.

In a two-stroke operation, a favorable scavenging gradient is generally higher, since the operation of charging fresh gas into a cylinder and the operation of ejecting exhaust gas from a cylinder, do not occur, by contrast in four-stroke operation, in respectively separate cycles, but together during one cycle. For this operation, also referred to as scavenging, it is necessary for a sufficiently high pressure to be applied to the fresh gas entering the cylinder in order to displace exhaust gas situated in the cylinder in an effective manner. This applies. stated here only by example, to a particularly advantageous head loop scavenging. In the case of any downstream exhaust gas turbochargers, the exhaust gas counterpressure is further increased, and the compression of the fresh gas must be further increased to ensure effective scavenging of the cylinder.

Since modern motors are generally operated with an exhaust gas turbocharger, they can realize, in the characteristic map of the motor, sometimes only relatively small differential pressures or scavenging gradients of, in particular, about 0.6 bar, particularly on account of the rigid, or mechanically directly coupled, connection between an exhaust gas turbocharger turbine and an exhaust gas turbocharger compressor. This value lies in a non-optimum range, in particular for two-stroke operation. Therefore, the switching between two-stroke operation and four-stroke operation in a manner which leads to technical and economic advantages has been possible to date, only to a limited degree.

The invention has recognized in particular, proceeding from these factual relationships, that a compressor which can be set variably in terms of power makes it possible, in an advantageous manner, to set a charging pressure required for a certain scavenging gradient, since the charging pressure can be set independently of the exhaust gas counterpressure.

According to the invention, there is therefore provision that the crankshaft can be driven by the power turbine via the first rotational movement, and the compressor can be driven by the crankshaft via the second rotational movement, wherein the second rotational movement for the compressor can be set differently from the first rotational movement of the power turbine.

To achieve the object, the concept of the invention also leads to a device as claimed for operating an internal combustion engine, and an internal combustion engine as claimed.

Accordingly, the device is provided for operating an internal combustion engine comprising a motor and a charger arrangement, wherein a charge air flow supplied to the motor is compressed by means of at least one compressor, and at least one turbine can be acted on by an exhaust gas flow discharged from the motor, in particular designed to carry out a method according to the concept of the invention for operating an internal combustion engine, wherein

the crankshaft can be driven by the power turbine via the first rotational movement,

the compressor can be driven by the crankshaft via the second rotational movement, and wherein

the second rotational movement for the compressor can be set differently from the first rotational movement of the power turbine.

The internal combustion engine includes a motor and a charger arrangement, wherein the charger arrangement has a power turbine for converting energy of an exhaust gas flow of the motor into a rotational movement, and a compressor for compressing a charge air flow for the motor. Wherein the internal combustion engine is designed to carry out a method according to the concept of the invention and/or comprises a device for operating an internal combustion engine.

Advantageous developments of the invention can be found in the dependent claims and specify in detail advantageous possibilities to realize the above-explained concept within the context of the set object and with regard to further advantages.

In particular, according to a concept of a development, the compressor is not directly mechanically coupled to the power turbine, but only indirectly, namely both compressor and power turbine can be coupled to the crankshaft of the motor by way of a coupling arrangement, furthermore achieving an advantageous possibility of energy recovery from the exhaust gas flow.

The “indirect coupling” means in particular that the power turbine and compressor are coupled via the crankshaft (instead of directly and rigidly, for example via a turbocharger shaft); hence, they are “mechanically decoupled”, that is to say in particular “not directly mechanically connected to one another”. “Indirectly” in this sense thus means that the power turbine and the compressor can be coupled to the crankshaft of the motor in a mechanical and torque-transmitting manner.

The energy recovered by the power turbine from the exhaust gas flow is thus not directly, or not exclusively, used for compressing the charge air but, according to the concept of the invention, is returned in the form of a rotational movement and thus in the form of kinetic energy to the motor by coupling the power turbine to the crankshaft of the motor.

From the crankshaft, this returned kinetic energy, together with the kinetic energy produced by the motor and the stored kinetic energy resulting from the mass inertia of the moving motor components, is consumed by an opposite output torque which results from the primary movement of the motor, for example the propulsion movement of a vehicle, and further drive-connected units. According to the concept of the invention, such units particularly also include the compressor, which can be connected to the crankshaft by means of a compressor coupling. In this way, the time point of energy recovery by the power turbine and the time point of energy provision for the compressor can be advantageously decoupled, particularly by contrast with a conventional exhaust gas turbocharger.

In particular, instead of a conventional, at least partial, direct use of the exhaust gas energy for compressing a charge of air in a customary mechanically directly coupled power turbine and compressor (for example via a rigid turbocharger shaft), a use of the exhaust gas energy can be advantageously used for recovering mechanical energy or movement energy by feeding the crankshaft of the motor by a power turbine, to be precise by the first rotational movement of the power turbine. According to the concept of the invention, by virtue of the decoupling of the power turbine and the compressor defined via the merely indirect drive, this first rotational movement of the power turbine can be reduced by the crankshaft and/or the compressor or precisely not be reduced; the second rotational movement for the compressor can thus in general be set differently from the first rotational movement of the power turbine.

Accordingly, the compressor can thus be indirectly driven by the power turbine by a second rotational movement for the compressor in the sense that the second rotational movement for the compressor is settable differently from the first rotational movement of the power turbine. In particular, the second rotational movement for the compressor can be set independently of the first rotational movement of the power turbine or is set according to the operation of the motor. This second rotational movement is, where appropriate, made available by the crankshaft via its coupling to the compressor and/or to the power turbine. The second rotational movement for the compressor can accordingly be set independently of the first rotational movement of the power turbine, for example with a suitable transmission ratio or freely as a result of the current operation of the motor. This is particularly advantageous if a relatively high scavenging gradient is intended to be achieved for a two-stroke operation.

The concept preferably offers the basis for an internal combustion engine which functions in an improved manner, since the switching possibility from two-stroke operation to four-stroke operation and the charger arrangement according to the invention interact in a synergistic manner and allow an efficient, in particular, resource-efficient, operation without substantial power losses which would occur in a conventional turbocharger.

Furthermore, it is advantageous in this approach according to the concept that, unlike in existing approaches for storing and subsequent use, the kinetic energy obtained from the power turbine does not have to be converted in a loss-associated manner into another energy form, in particular electrical energy, but is supplied directly, that is to say in kinetic form, to the crankshaft. The same applies to conversion losses in the subsequent back-conversion particularly in electrical energy stores from electrical into kinetic energy, which do not occur in this approach according to the concept.

Consequently, the motor is relieved during a return of the kinetic energy via the power turbine to the crankshaft according to the concept, which leads to an advantageous saving of fuel.

It is analogously possible according to the concept, for the purpose of driving the compressor, for the crankshaft to be coupled to the compressor, in particular in the case of a spontaneous power requirement. The mass moment of inertia of the crankshaft and, where appropriate, of all components of the drive train which are connected in a torque-transmitting manner (including the inertia of the moving vehicle) means that the compressor can be brought comparatively abruptly to nominal rotational speed in order to meet the spontaneous power requirement, in particular by contrast with a conventional exhaust gas turbocharger which is to be accelerated only by impingement with exhaust gas.

In particular, there is provision that the method further includes the step of switching from a four-stroke operation of the first operating mode to a two-stroke operation of the second operating mode. In concrete terms, this development particularly includes the switching during operation from a four-stroke operation to a two-stroke operation, in order, in particular according to the concept of the invention, to advantageously achieve a higher power of the motor in the short term. This is particularly advantageously possible since a sufficiently high scavenging gradient can be produced by the mechanical decoupling of power turbine and compressor according to the concept of the invention in spite of the two-stroke operation.

Within the context of a particularly preferred development, there is provision that the method further comprises the step of switching from a two-stroke operation of the second operating mode to a four-stroke operation of the first operating mode. This can mean in concrete terms that the motor of the internal combustion engine, after it has already been switched in a previous step from a four-stroke operation to a two-stroke operation, is switched back again to a four-stroke operation. This is particularly advantageous if the higher power of the two-stroke operation, which is advantageously used in the case of transient requirements, such as, for example, during acceleration, is not required in an instantaneous operating state of the motor. In such an, in particular stationary, operating state, the internal combustion engine can therefore, according to the concept of the invention, be switched in favor of a lower fuel consumption and lower pollutant emissions to a four-stroke operation.

In particular, there is provision that the power turbine can be coupled via a turbine coupling to the crankshaft of the motor. This particularly comprises, in concrete terms, the drive connection between power turbine and crankshaft of the motor being able to be closed and opened. This advantageously makes it possible for the transmission of the rotational movement produced by the power turbine to the crankshaft of the motor to be established, to be interrupted or even to be gradually or partially set depending on the requirement. It is thereby possible to ensure, for example, that a slower rotating shaft driven by the power turbine is separated from the crankshaft in order to avoid a braking action on the motor.

Within the context of a particularly preferred development, there is provision that the turbine coupling is designed as a hydrodynamic coupling, in particular as a fill-controlled hydrodynamic coupling. In concrete terms, this particularly comprises the fact that a turbine output shaft of the power turbine is connected via a hydrodynamic coupling to the crankshaft of the motor, in particular furthermore via a transmission. According to the principle of a hydrodynamic coupling, the torque is in particular not transmitted directly, but by the driving of a fluid surrounding both coupling partners. This advantageously ensures that in particular rotational speed jumps of one coupling partner are transmitted in a virtually jerk-free manner to the other coupling partner by the continuous adjustment of the flow velocity of the fluid. In general, torsional vibrations are damped by a hydrodynamic transmission, which thus contributes positively to the running smoothness. Furthermore, such a development particularly comprises the fact that the fluid for coupling both coupling partners can be filled into the coupling space of the hydrodynamic coupling that encloses the two coupling partners or can be let out of the coupling space in a controlled or regulated manner. This advantageously makes it possible for the transmission power of the hydrodynamic coupling, and in particular the transmitted rotational speed, to be continuously adapted during operation.

Within the context of a particularly preferred embodiment, there is provision that the compressor can be coupled via a compressor coupling to the crankshaft of the motor. In concrete terms, this particularly comprises the fact that the drive connection between crankshaft of the motor and compressor can be closed and opened depending on the requirement. This advantageously makes it possible for the transmission of the rotational movement produced by the crankshaft of the motor to the compressor to be established, to be interrupted or even to be gradually or partially set depending on the requirement. It is thus advantageously possible to set the power of the compressor and hence the degree of compression of the charge air depending on the instantaneous requirements and currently prevailing operating conditions, in particular continuously or virtually continuously in the manner of a control circuit. This is particularly advantageous by comparison with a conventional rigid drive connection between turbine and compressor, in which such a setting is not readily possible.

In particular, there is provision that the compressor coupling is designed as a hydrodynamic coupling, in particular as a fill-controlled hydrodynamic coupling. In concrete terms, this particularly comprises the fact that a drive shaft of the compressor is connected via a hydrodynamic coupling to the crankshaft of the motor. According to the principle of a hydrodynamic coupling, the torque is in particular not transmitted directly, but by the driving of a fluid surrounding both coupling partners. This advantageously ensures that in particular rotational speed jumps of one coupling partner are transmitted in a virtually jerk-free manner to the other coupling partner by the continuous adjustment of the flow velocity of the fluid. In general, torsional vibrations are damped by a hydrodynamic transmission, which thus contributes positively to the running smoothness. In concrete terms, this means in particular that the fluid for coupling both coupling partners can be filled into the coupling space of the hydrodynamic coupling that encloses the two coupling partners or can be let out of the coupling space in a controlled or regulated manner. This advantageously makes it possible for the transmission power of the hydrodynamic coupling to be continuously adapted during operation, and in particular, for the rotational speed of the compressor to be controlled or regulated during operation. Furthermore, such a development particularly comprises the fact that the fluid for coupling both coupling partners can be filled into the coupling space of the hydrodynamic coupling that encloses the two coupling partners or can be let out of the coupling space in a controlled or regulated manner. This advantageously makes it possible for the transmission power of the hydrodynamic coupling to be continuously adapted during operation and in particular for the rotational speed of the compressor to be controlled or regulated during operation.

In particular, there is provision that the power turbine can furthermore be coupled to the crankshaft via a power turbine transmission arranged between turbine coupling and crankshaft. In concrete terms, this means that the rotational speed of the power turbine can be changed, in particular reduced, before being fed into the motor. For this purpose, the rotational speed of the generally quicker rotating power turbine can be reduced by a transmission, in particular with a transmission ratio of i=25-30. This advantageously makes possible the use of recovered exhaust gas energy in mechanical form by the direct transmission to the crankshaft of the motor.

Within the context of a particularly preferred development, there is provision that the compressor can furthermore be coupled to the crankshaft via a compressor transmission arranged between the compressor coupling and the crankshaft. In concrete terms, this particularly comprises the fact that the rotational speed of the crankshaft of the motor is changed, in particular increased, by means of a compressor transmission in order to drive the compressor with an adapted rotational speed which is sufficiently high in particular for compressing the charge air. This advantageously makes it possible to directly use the rotational movement of the motor by means of a corresponding transmission ratio for the charge air compression.

Within the context of a preferred development, the invention has recognized that, for the use and scavenging method in two-stroke operation, in particular head loop scavenging has proved advantageous by comparison with a two-stroke operation with longitudinal scavenging; with particular advantage, head loop scavenging requires only minor structural adaptations of the internal combustion engine. In particular, there is accordingly provision that, during operation of the internal combustion engine in two-stroke operation, the cylinders are scavenged by head loop scavenging. In concrete terms, this means in particular that the combustion chamber formed from the cylinder and the piston is scavenged, that is to say flooded and emptied, via openings or valves which are arranged on a side of the combustion chamber, in particular on the upper inner side or head side of the cylinder. Such a development leads in particular to the advantage that the construction of the power unit and in particular of the individual cylinders is identical or similar to the construction of a four-stroke motor, and consequently an adaptation to allow both operating modes requires only minor structural changes to the internal combustion engine. It is thereby possible, substantially in particular by adapting the valve timing, for example by hydraulic adjustment of the camshaft, to switch between two-stroke operation and four-stroke operation.

Furthermore, in the case of head loop scavenging, the piston or any piston rings and/or piston seals are advantageously not mechanically stressed by running over inlet slots which are arranged, in particular in the lower cylinder region, for implementing other scavenging methods, such as, for example, longitudinal scavenging or uniflow scavenging. This advantageously reduces the risk of damage to, or increased wear of, the piston or any piston rings and/or piston seals.

The possibility of setting a higher scavenging gradient, which is required in the case of head loop scavenging particularly by contrast with longitudinal scavenging, is advantageously achieved by the coupleability of power turbine and compressor via the crankshaft of the motor according to the concept of the invention.

With regard to the internal combustion engine, there is provision in a development that the coupling arrangement is of electromechanical design, in particular that a rotational movement can be converted into a generator current, or the generator current can be converted into a rotational movement. In concrete terms, this particularly comprises the fact that, both on the turbine and compressor side, an arrangement consisting of a generator, a regulator and motor allows a conversion of kinetic, in particular rotational, energy into electrical energy and furthermore a regulation and a subsequent back-conversion of electrical energy into kinetic energy. Such a development particularly advantageously makes it possible, both on the turbine side and the compressor side, for a rotational speed conversion to occur through the conversion of movement energy into electrical energy, and vice versa. Furthermore, it is also possible that the movement energy converted into electrical energy can be stored by suitable energy stores, in particular batteries, and can be converted back at a later time point into movement energy again.

In a preferred development of the internal combustion engine, there is provision that the exhaust gas turbine drives a generator. The current produced by this generator drives an electric motor which is mechanically connected to the crankshaft of the motor via a suitable transmission ratio. Consequently, the energy produced by the exhaust gas turbine is transmitted to the motor. By controlling/regulating the electric motor, the maximum available energy can be transmitted from the motor in the entire characteristic map of the motor.

In a preferred development of the internal combustion engine, there is provision that the crankshaft of the motor mechanically drives a generator. The current produced by this generator drives an electric motor which is mechanically connected to the compressor via a suitable transmission ratio. Consequently, the energy produced by the motor (independently of the available exhaust gas enthalpy) is transmitted to the compressor. By controlling/regulating the electric motor, the optimum rotational speed for the compressor can be set in the entire characteristic map of the motor.

Embodiments of the invention will now be described below with reference to the drawing. The latter is not necessarily intended to represent the embodiments to scale; rather, the drawing takes a schematized and/or slightly distorted form where useful for explanatory purposes. With regard to additions to the teachings which are directly evident from the drawing, reference is made to the relevant prior art. Here, it should be taken into consideration that a wide variety of modifications and changes concerning the form and the detail of an embodiment can be made without departing from the general idea of the invention. The features of the invention which are disclosed in the description, in the drawing and in the claims may be essential both individually and in any desired combination for the development of the invention. In addition, the scope of the invention covers all combinations of at least two features disclosed in the description, the drawing and/or the claims. The general idea of the invention is not restricted to the exact form or the detail of the preferred embodiments shown and described below or limited to subject matter which would be restricted by comparison with the subject matter claimed in the claims. Where dimensional ranges are specified, values lying within the stated limits are also intended to be disclosed as limit values and able to be used and claimed as desired. For the sake of simplicity, identical reference signs are used below for identical or similar parts or parts having an identical or similar function.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A shows a schematic illustration of one sequence of a two-stroke combustion process;

FIG. 1B is a schematic illustration of another sequence of the two-stroke combustion process;

FIG. 2A shows a schematic illustration of one sequence of a four-stroke combustion process that is sequentially shown in FIGS. 2A-2D;

FIG. 2B shows a schematic illustration of one sequence of the four-stroke combustion process that is sequentially shown in FIGS. 2A-2D;

FIG. 2C shows a schematic illustration of one sequence of the four-stroke combustion process that is sequentially shown in FIGS. 2A-2D;

FIG. 2D shows a schematic illustration of one sequence of the four-stroke combustion process that is sequentially shown in FIGS. 2A-2D;

FIG. 3 shows a schematic illustration of a development of a charger arrangement according to an embodiment of the present invention;

FIG. 4 shows a schematic illustration of an alternative implementation according to another embodiment of the present invention;

FIG. 5 shows a schematic illustration of scavenging of a cylinder in two-stroke operation according to the concept of the invention; and

FIG. 6 shows a motor characteristic map applicable to the motor components of the present invention illustrated in FIGS. 1-5.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

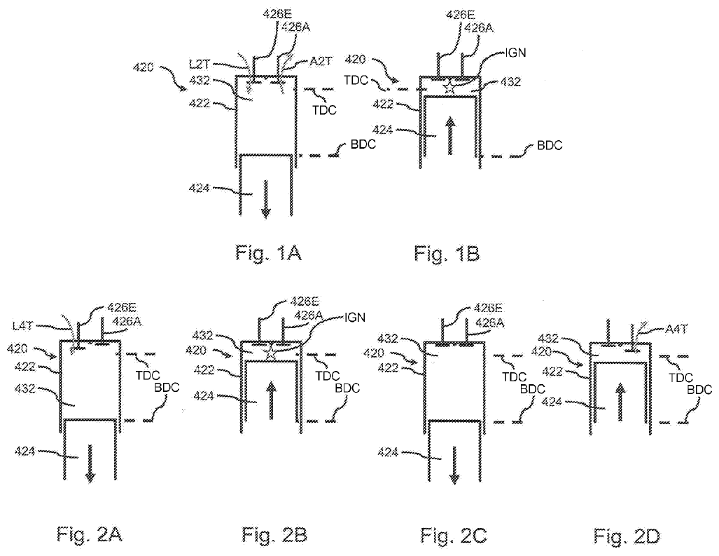

Now referring to the drawings, and more particularly to FIG. 1A and FIG. 1B that show a schematic illustration of the sequence of a two-stroke combustion process. FIG. 1A illustrates a cylinder 420 in which there is arranged a piston 424, which is movable translationally in the direction of the cylinder axis of cylinder 420. In the illustration, piston 424 is situated in the vicinity of bottom dead center BDC. According to the principle of head loop scavenging, gas, in particular a two-stroke charge air flow L2T, flows into a combustion chamber 432 formed substantially from a cylinder wall 422 of cylinder 420 and piston 424. For this purpose, charge air L2T is conveyed through at least one inlet valve 426E into combustion chamber 432.

Two-stroke charge air flow L2T is for this purpose previously compressed to a sufficiently high pressure for the two-stroke operation by a compressor 300 which is driven according to the concept of the invention. At the same time, exhaust gas situated in combustion chamber 432 is displaced as charge air flow L2T flows in. This exhaust gas leaves combustion chamber 432 in the form of a two-stroke exhaust gas flow A2T through at least one outlet valve 426A which in the present case is arranged on the upper side of cylinder 420 in the vicinity of top dead center TDC.

The operation illustrated in FIG. 1A thus comprises a charging of combustion chamber 432 with charge air L2T and virtually at the same time an ejection of exhaust gas A2T.

In FIG. 2B, piston 424 is situated in the vicinity of top dead center TDC, that is to say combustion chamber 432 has nearly reached its minimum volume. This means that charge air L2T which previously flowed into combustion chamber 432 has been compressed by the upward movement of piston 424 and thus by the reduction of combustion chamber 432. Here, inlet valve 426E and outlet valve 426A, 426 are closed to prevent charge air L2T from exiting. The state illustrated represents virtually the end of the compression operation.

An ignition IGN of the compressed gas in combustion chamber 432 then causes piston 426 to be moved downward in the direction of bottom dead center BDC by the expanding gas in the phase which is also referred to as working phase. Virtually upon bottom dead center BDC being reached by piston 424, the cycle begins anew by the charging or ejecting operation illustrated in FIG. 1A.

Now, additionally referring to FIGS. 2A to 2D, there is shown a schematic illustration of the sequence of a four-stroke combustion process. FIG. 2A illustrates the operation of charging in a cylinder 420. By virtue of the position of a piston 424 close to bottom dead center TBC, combustion chamber 432 has virtually its largest possible volume. Particularly by previous pressurization by a compressor 300 (not shown here in more detail) and/or by a negative pressure produced by the downward movement of piston 424, a four-stroke charge air flow L4T flows through opened inlet valve 426E into combustion chamber 432. By contrast to the two-stroke operation illustrated in FIG. 1A, outlet valve 426A is closed in the present case.

In FIG. 2B, piston 424 is situated close to top dead center TDC. Inlet valve 426E and outlet valve 426A are closed; the gas which flowed in in the previous step illustrated in FIG. 2A is thus already compressed at the presently illustrated time point. The state illustrated in FIG. 2B represents virtually the end of the compression. There occurs an ignition IGN.

In FIG. 2C, piston 424 is again situated at bottom dead center BDC. This state has been preceded by an expansion by ignition IGN of the compressed gas, which in turn has occurred subsequent to the end state of compression illustrated in FIG. 2B. The state illustrated in FIG. 2C thus represents virtually the end of the work or the working phase in which in particular a drive movement of a motor 1200 is produced.

In FIG. 2D, there finally occurs the ejection of an exhaust gas which has arisen during the preceding expansion or ignition. For this purpose, outlet valve 426A is opened such that, during an upward movement of piston 424 or with a reduction of combustion chamber 432, the exhaust gas leaves combustion chamber 432 in the form of a four-stroke exhaust gas flow A4T.

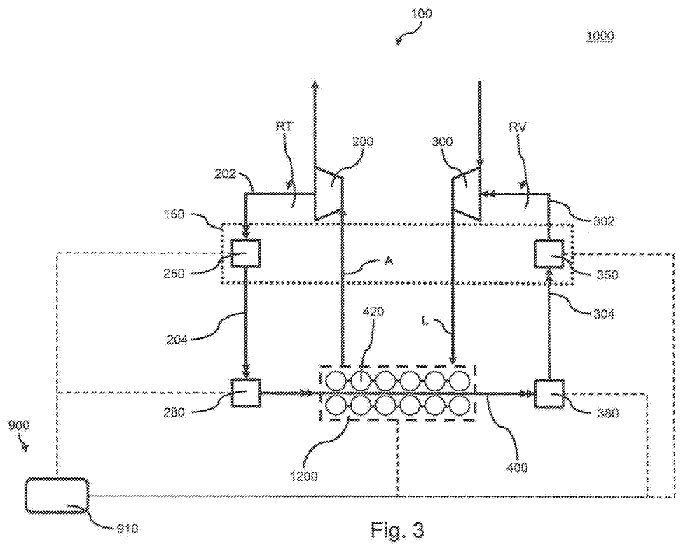

FIG. 3 shows a schematic illustration of a development of a charger arrangement 100 according to the concept of the invention. Here, charger arrangement 100 comprises in particular a power turbine 200 and a compressor 300. An exhaust gas flow A discharged from a motor 1200 is in particular guided completely through power turbine 200 in which the energy of the exhaust gas is converted into movement energy, in particular into a first rotational movement RT. Charger arrangement 100 further comprises a coupling arrangement 150. In the present case, the rotational movement produced by the power turbine is transmitted via a turbine output shaft 202 to a turbine coupling 250, which is preferably designed as a hydrodynamic coupling.

The hydrodynamic coupling makes it possible in particular for rotational speed jumps to be adapted in a jerk-free manner or jerk-reducing manner and for torsional vibrations to be advantageously damped. The rotational movement is further transmitted from turbine coupling 250 via a power turbine transmission drive shaft 204 to a power turbine transmission 280 which serves particularly for rotational speed adaptation of the rotational movement produced by power turbine 200. The rotational speed adaptation occurs in particular to reduce or step down the generally relatively high rotational speed of power turbine 200 to a rotational speed suitable for coupling into a crankshaft 400 of motor 1200. Typical step-up or step-down ratios here are between 25 and 30.

The stepped-down rotational movement is transmitted from power turbine transmission 280 to crankshaft 400 of motor 1200. In this way, the energy obtained from exhaust gas flow A is returned in mechanical form to motor 1200. With particular preference, power turbine transmission 280 further comprises a freewheel in order to prevent the power flow in the case that the rotational speed of power turbine transmission drive shaft 204 is less than the rotational speed of crankshaft 400.

Furthermore, according to the concept of the invention, a compressor transmission 380 is driven by crankshaft 400 of motor 1200. Compressor transmission 380 changes the rotational speed of the rotational movement emanating from crankshaft 400 in such a way that it is suitable, in particular sufficiently high, to drive compressor 300.

The correspondingly stepped-up rotational movement is then transmitted via a compressor transmission output shaft 304 from compressor transmission 380 to a compressor coupling 350, which in turn provides a second rotational movement RV for compressor 300 which is transmitted via a compressor drive shaft thereto. Analogously to turbine coupling 250, compressor coupling 350 has the advantage that rotational speed jumps are adjusted in particular in a jerk-free manner and torsional vibrations are damped by the mode of operation of a hydrodynamic coupling. In particular, a fill-controlled hydrodynamic coupling ensures that the transmission power of the compressor coupling can be controlled or regulated by adapting the filling level of a coupling fluid within a coupling space 258. In particular, it is possible in this way for a rotational speed of compressor 300 that is optimum in each case for an instantaneous operating state of motor 1200 to be set in a regulating manner.

Compressor 300, which in the present case is designed as a flow compressor, is mechanically driven in this manner by the rotational movement of crankshaft 400. Consequently, compressor 300 can advantageously compress a charge air flow L supplied to motor 1200.

Also schematically illustrated is a device 900 for operating internal combustion engine 1000, which in the present case comprises a regulating and processor means 910. As illustrated in the present case by dashed lines, this regulating and processor means 910 is connected in a signal-conducting manner to turbine coupling 250, power turbine transmission 280, compressor coupling 350 and compressor transmission 380. In this way, the concept of the invention can be implemented for example in the sense of an automatic system or control circuit illustrated in this preferred embodiment. In particular, the rotational movements, that is to say here the rotational movements RT and RV, can be set according to this embodiment. These rotational movements RT and RV can be stepped up or stepped down by actuating power turbine transmission 280 and/or compressor transmission 380.

Additionally or alternatively, the transmission of the rotational movement can be interrupted or used by actuating turbine coupling 250 and/or compressor coupling 350.

Furthermore, the regulating and processor means 910 is in signal-conducting connection with an, in particular superordinate, controller of internal combustion engine 1000, said controller being only indicated here, but not shown in further detail. Additionally or alternatively, it can also be part thereof in order to implement the method according to the concept of the invention, in particular the switching of motor 1200 from two-stroke operation to four-stroke operation or from four-stroke operation to two-stroke operation.

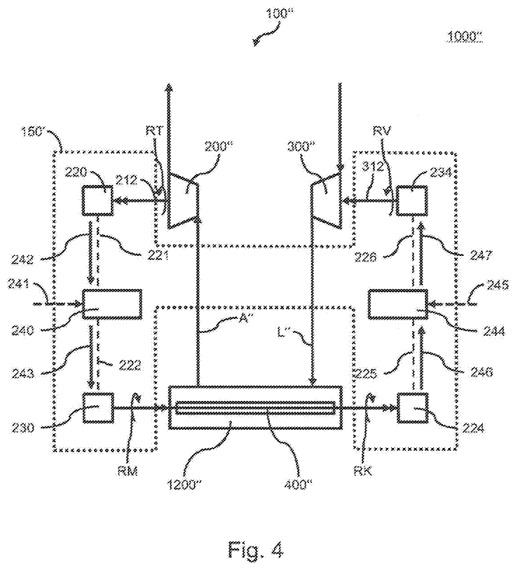

FIG. 4 shows a schematic illustration of an alternative implementation according to the concept of the invention. There is shown an internal combustion engine 1000″ having a charger arrangement 100″ which comprises a power turbine 200″ and a compressor 300″. Power turbine 200″ is acted on by an exhaust gas flow A″ originating from a motor 1200″.

The thus produced movement energy or rotational movement RT is transmitted via a generator drive shaft 212 to a turbine-side generator 220. This turbine-side generator 220 converts the movement energy into electrical energy which is transmitted via a turbine-side generator line 221 particularly in the form of a turbine-side generator current 242 to a turbine regulator 240.

In turbine regulator 240, turbine-side generator current 242 is regulated according to setpoint values 241 which originate in particular from a superordinate controller, in particular motor electronics. A turbine-side generator current 243 regulated in this way is then transmitted via a turbine-side motor line 222 to a turbine-side motor 230. The latter is connected in a torque-transmitting manner to a crankshaft 400″ of motor 1200″, with the result that a rotational movement RM produced by turbine-side motor 230 can be used to drive crankshaft 400″, in particular to support the rotational movement RK of crankshaft 400″.

By contrast with the development shown in FIG. 3, there thus does not take place in the present case a complete mechanical recovery of the exhaust gas energy. Instead, a conversion into electrical energy, a regulation and a subsequent back-conversion into mechanical energy result in an electromechanical recovery of the exhaust gas energy.

Furthermore, according to the concept of the invention, crankshaft 400″ in this development is connected in a torque-transmitting manner to a compressor-side generator 224.

This compressor-sign generator 224 converts the movement energy transmitted by crankshaft 400″ in the form of a rotational movement into electrical energy which is transmitted in particular in the form of a compressor-side generator current 246 via a compressor-side generator line 225 to a compressor regulator 244. In this compressor regulator 244, compressor-side generator current 246 is regulated according to setpoint values 245 for compressor regulator 244. Analogously to turbine regulator 240, setpoint values 245 likewise originate in particular from a superordinate controller, in particular motor electronics.

A regulated compressor-side generator current 247 is then channeled via a compressor-side motor line 226 to a compressor-side motor 234. This compressor-side motor 234 is connected in a torque-transmitting manner to compressor 300″ via a compressor drive shaft 312. The driving of compressor 300″ by compressor-side motor 234 therefore compresses a charge air flow L″ which is supplied to motor 1200″.

By contrast to the development shown in FIG. 3, in the present case a rotational movement is electromechanically transmitted from crankshaft 400″ to compressor 300″, that is to say not completely mechanically, but by a conversion of movement energy into electrical energy, a regulation and a back-conversion of electrical energy into movement energy. What is concerned in the present case is thus an electromechanical coupling arrangement 150′.

Such a development particularly advantageously makes it possible, both on the turbine side and compressor side, for a rotational speed conversion to occur through the conversion of movement energy into electrical energy, and vice versa. Furthermore, it is also possible that the movement energy converted into electrical energy can be stored by suitable energy stores, in particular batteries, and can be converted back at a later time point into movement energy again.

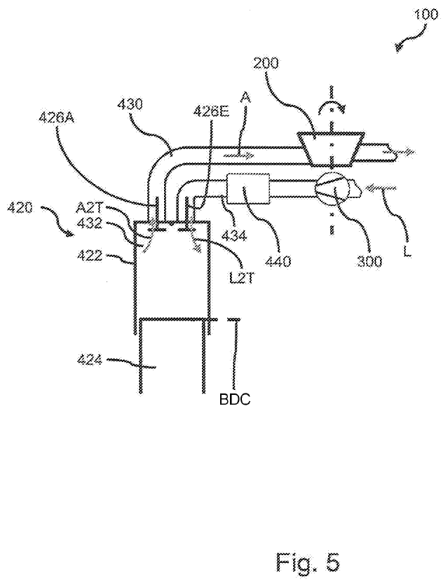

FIG. 5 further shows the principle of the scavenging of a cylinder 420 particularly in two-stroke operation. For this purpose, the cylinder is illustrated in a state analogous to the state shown in FIG. 1A. Here, combustion chamber 432 is pronounced virtually as far as possible, that is to say piston 424 is situated virtually at bottom dead center BDC. A charge air flow L2T flows through at least one inlet valve 426E into combustion chamber 432. According to the concept of the invention, a charge air flow L is compressed by a compressor 300 and channeled into at least one supply duct 434 via a charge air cooler 440 and a distributor (not shown in more detail here). Here, according to the concept of the invention, compressor 300 is not directly mechanically connected to power turbine 200, as would be the case in the transferred sense in an exhaust gas turbocharger. In the present case, a torque-transmitting connection between power turbine 200 and compressor 300 is substantially produced via a coupling arrangement 150 (not shown here) and a crankshaft 400. In this way, there is in particular the possibility of closing or opening the torque-transmitting connection or of only partially producing it in particular by a fill-controlled hydrodynamic coupling, in particular to influence the rotational speed of the transmitted rotational movement. Furthermore, there is the possibility of stepping up or stepping down the rotational movement by means of transmissions (not shown further here).

Furthermore, the flow of charge air flow L2T into combustion chamber 432 according to the concept of a two-stroke motor is accompanied by the simultaneous ejection of an exhaust gas flow A2T via at least one opened outlet valve 426A and furthermore an exhaust gas manifold 430. Exhaust gas flow A is furthermore channeled to power turbine 200 in which the remaining energy contained in exhaust gas flow A is further converted into a mechanical rotational movement. However, this energy is lower by comparison with an exhaust gas flow A4T discharged in four-stroke operation.

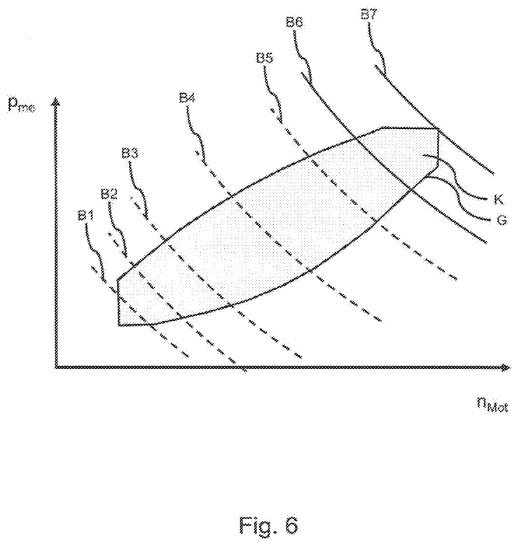

FIG. 6 schematically shows the characteristic map of a motor. Here, the effective average pressure p_{mc}, is plotted on the ordinate and is for its part proportional to torque M_{d} of the motor via the following relationship:

$${p}_{me} = \frac{{M}_{d} * 2 π}{{V}_{H} * i}$$

Here, furthermore, V_{H} is the total swept volume of the motor and i is the number of working cycles per revolution (0.5 for four-stroke operation, 1 for two-stroke operation).

The motor rotational speed n_{Mot} is plotted on the abscissa. Furthermore, isolines B1-B7 each denote operating points of equal effective motor power Pₑ. Operating point B1 corresponds in the present case to a motor power of 10%, operating point B2 to a motor power of 20%, operating point B3 to a motor power of 30%, operating point B4 to a motor power of 50%, and operating point B5 to a motor power of 70%. According to the concept of the invention, switching to 2-stroke operation is possible or expedient at any time in these operating points B1-B5, in particular to increase the motor power in the short term and to achieve an operating point in an upper region further to the right in the diagram illustrated here. Isolines B6 and B7 illustrated as solid lines show certain operating points of the motor. Here, isoline B6 corresponds to a motor power of 80%, and isoline B7 corresponds to a motor power of 100%. Such operating points are approached particularly in standby-state operation, where an operation in two-stroke operation is not advantageous. A two-stroke operation is therefore expedient whenever, particularly in the transient range, quick power jumps are intended to be achieved. The area K furthermore denotes the total power range of the motor, which is delimited by limit G enclosing power range K.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

100, 100″ Charger arrangement
150, 150′ Coupling arrangement
200, 200″ Power turbine
202 Turbine output shaft
204 Power turbine transmission drive shaft
212 Generator drive shaft
220 Turbine-side generator
221 Turbine-side generator line
222 Turbine-side motor line
224 Compressor-side generator
225 Compressor-side generator line
226 Compressor-side motor line
230 Turbine-side motor
234 Compressor-side motor
240 Turbine regulator
241 Setpoint values for the turbine regulator
242 Turbine-side generator current
243 Regulated turbine-side generator current
244 Compressor regulator
245 Setpoint values for the compressor regulator
246 Compressor-side generator current
247 Regulated compressor-side generator current
250 Turbine coupling
258 Coupling space
280 Power turbine transmission
300, 300″ Compressor
302 Compressor drive shaft
304 Compressor transmission output shaft
312 Compressor drive shaft
350 Compressor coupling
380 Compressor transmission
400, 400″ Crankshaft
420 Cylinder
422 Cylinder wall
424 Piston
426 Valve
426A Outlet valve
426E Inlet valve
430 Exhaust gas manifold
432 Combustion chamber
434 Supply duct
440 Charge air cooler
900 Device for operating an internal combustion engine
910 Regulating and processor means
1000, 1000″ Internal combustion engine
1200, 1200″ Motor
A, A″ Exhaust gas flow
A2T Cylinder exhaust gas flow in 2-stroke operation
A4T Cylinder exhaust gas flow in 4-stroke operation
B1-B7 Isolines with operating points each of equal effective motor power
G Limit of the power range
K Power range
L, L″ Charge air flow
L2T Cylinder charge air flow in 2-stroke operation
L4T Cylinder charge air flow in 4-stroke operation
TDC Top dead center
RK Rotational movement of the crankshaft
RM Rotational movement of the turbine-side motor
RT Rotational movement of the power turbine, first rotational movement
RV Rotational movement for the compressor, second rotational movement
BDC Bottom dead center
IGN Ignition

What is claimed is:

1. A method for operating an internal combustion engine, the internal combustion engine including a motor having a crankshaft, the method comprising the steps of:
compressing a charge air flow with a compressor and supplying the charge air flow to the motor, the compressing of the charge air flow taking place via a second rotational movement and a power turbine for producing a first rotational movement acted on by an exhaust gas flow discharged from the motor;
operating the internal combustion engine in a first operating mode, the first operating mode being a four-stroke operation of the motor;
operating the internal combustion engine in a second operating mode, the second operating mode being a two-stroke operation of the motor;
driving the crankshaft by the power turbine by way of the first rotational movement; and
driving the compressor by the crankshaft by way of the second rotational movement, the second rotational movement for the compressor being settable differently from the first rotational movement of the power turbine.

2. The method as claimed in claim 1, further comprising the step of switching from the four-stroke operation of the first operating mode to the two-stroke operation of the second operating mode.

3. The method as claimed in claim 1, further comprising the step of switching from the two-stroke operation of the second operating mode to the four-stroke operation of the first operating mode.

4. The method as claimed in claim 1, wherein the power turbine is couplable by way of a turbine coupling to the crankshaft of the motor.

5. The method as claimed in claim 4, wherein the turbine coupling is a hydrodynamic coupling, in particular a fill-controlled hydrodynamic coupling.

6. The method as claimed in claim 1, wherein the compressor is coupled by way of a compressor coupling to the crankshaft of the motor.

7. The method as claimed in claim 6, wherein the compressor coupling is a hydrodynamic coupling, in particular a fill-controlled hydrodynamic coupling.

8. The method as claimed in claim 1, wherein the power turbine is coupled to the crankshaft via a power turbine transmission arranged between the turbine coupling and the crankshaft.

9. The method as claimed in claim 1, wherein the compressor is coupled to the crankshaft via a compressor transmission arranged between the compressor coupling and the crankshaft.

10. The method as claimed in claim 1, wherein during operation of the internal combustion engine in two-stroke operation the cylinders are scavenged by head loop scavenging.

11. A device for operating an internal combustion engine having a motor with a crankshaft, the device comprising:
a charger arrangement including:
at least one compressor that supplies a charge air flow to the motor, the compressor compressing the charge air; and
at least one power turbine that is acted on by an exhaust gas flow discharged from the motor, the charger arrangement carrying out a method including the steps of:
compressing a charge air flow with the at least one compressor and supplying the charge air flow to the motor, the compressing of the charge air flow taking place via a second rotational movement and the power turbine for producing a first rotational movement acted on by an exhaust gas flow discharged from the motor;
operating the internal combustion engine in a first operating mode, the first operating mode being a four-stroke operation of the motor;
operating the internal combustion engine in a second operating mode, the second operating mode being a two-stroke operation of the motor;
driving the crankshaft by the power turbine by way of the first rotational movement; and
driving the compressor by the crankshaft by way of the second rotational movement, the second rotational movement for the compressor is set differently from the first rotational movement of the power turbine.

12. An internal combustion engine, comprising:
a motor with a crankshaft; and
a charger arrangement including:
at least one compressor that supplies a charge air flow to the motor, the compressor compressing the charge air; and
at least one power turbine that is acted on by an exhaust gas flow discharged from the motor, the charger arrangement carrying out a method including the steps of:
compressing a charge air flow with the at least one compressor and supplying the charge air flow to the motor, the compressing of the charge air flow taking place via a second rotational movement and the power turbine producing a first rotational movement is acted on by an exhaust gas flow discharged from the motor;
operating the internal combustion engine in a first operating mode, the first operating mode being a four-stroke operation of the motor;
operating the internal combustion engine in a second operating mode, the second operating mode being a two-stroke operation of the motor;
driving the crankshaft by the power turbine by way of the first rotational movement; and
driving the compressor by the crankshaft by way of the second rotational movement, the second rotational movement for the compressor is set differently from the first rotational movement of the power turbine.

13. The internal combustion engine as claimed in claim 12, wherein the driving steps are carried out by a coupling arrangement that is of electromechanical design, wherein the first rotational movement is converted into a generator current or the generator current is converted into the second rotational movement.

14. The internal combustion engine as claimed in claim 12, wherein the power turbine drives a generator.

15. The internal combustion engine as claimed in claim 12, wherein the crankshaft of the motor drives a generator.
